(19) United States
(12) Patent Application Publication
(10) Pub. No.: US 2024/0403339 A1
(43) Pub. Date: Dec. 5, 2024

(54) DOCUMENT RECOMMENDATION USING CONTEXTUAL EMBEDDINGS

(71) Applicant: ADOBE INC., SAN JOSE, CA (US)

(72) Inventors: Vahid Azizi, San Jose, CA (US); Chun Hao Wang, San Jose, CA (US); Somdeb Sarkhel, San Jose, CA (US); Saayan Mitra, San Jose, CA (US); Richard Pong Nam Sinn, Milpitas, CA (US)

(21) Appl. No.: 18/328,925

(22) Filed: Jun. 5, 2023

(51) Int. Cl. G06F 16/33; G06F 40/205; G06F 40/30

(52) U.S. Cl. CPC G06F 16/3344; G06F 40/205; G06F 40/30

(57) ABSTRACT

Systems and methods for generating contextual document embeddings and recommending similar articles based on the document embeddings are described. Embodiments are configured to receive a document query and encode a plurality of candidate sentences from a candidate document to obtain a plurality of contextual sentence embeddings. The contextual sentence embeddings each represent a semantic context of a corresponding sentence from the plurality of candidate sentences. Embodiments then generate a candidate document embedding by combining the plurality of contextual sentence embeddings and provide the candidate document in response to the document query based on the candidate document embedding.

### BACKGROUND

The following relates generally to natural language processing, and more specifically to article recommendation. Natural language processing, or NLP, is a type of data processing that involves using computers and software to extract meaningful information from language. NLP can include the processing of text data as well as audio. Some applications of NLP include speech recognition, language translation, sentiment analysis, natural language generation, and topic modeling.

Topic modeling is a technique used in NLP to automatically identify topics or themes within a collection of text data. Document representation, or vector representation, is related to topic modeling and involves condensing a document's information into a tensor of values that can be used for downstream tasks such as classification and retrieval. However, methods for document representation that are based on the frequencies of words within a document can miss contextual information. This can cause misrepresentation of the documents, leading to inaccuracies in document retrieval. There is a need in the art for systems and methods to generate document embeddings that capture the contextual information of documents.

### SUMMARY

Embodiments configured to generate document embeddings and retrieve similar documents based on the embeddings are described herein. Embodiments include a document search apparatus configured to divide a document into constituent sentences, encode each of the sentences to generate contextual sentence embeddings using a sentence encoder model, and then combine the sentence embeddings to generate a document embedding. In an example use case, the system processes an article currently being viewed by a user, as well as other available articles in a database. The system processes the articles to generate several document embeddings. Then, when the user indicates that they wish to see similar articles, the system compares the embeddings, and identifies articles similar to the current article based on the comparison. In this way, the system is configured to provide a user with relevant content.

A method, apparatus, non-transitory computer readable medium, and system for article recommendation are described. One or more aspects of the method, apparatus, non-transitory computer readable medium, and system include receiving a document query; encoding a plurality of candidate sentences from a candidate document to obtain a plurality of contextual sentence embeddings, wherein each of the plurality of contextual sentence embeddings represents a semantic context of a corresponding sentence from the plurality of candidate sentences; generating a candidate document embedding by combining the plurality of contextual sentence embeddings; and providing the candidate document in response to the document query based on the candidate document embedding.

An apparatus, system, and method for article recommendation are described. One or more aspects of the apparatus, system, and method include a non-transitory computer readable medium storing code, the code comprising instructions executable by a processor to: encode a plurality of candidate sentences from a candidate document to obtain a plurality of contextual sentence embeddings, wherein each of the plurality of contextual sentence embeddings represents a semantic context of a corresponding sentence from the plurality of candidate sentences; generate a candidate document embedding by combining the plurality of contextual sentence embeddings; and identify a document based on the candidate document embedding.

Some examples of the non-transitory computer readable medium further include code executable by the processor to obtain a query document based on a document query; encode a plurality of query sentences from the query document to obtain a plurality of query sentence embeddings; generate a query document embedding by combining the plurality of query sentence embeddings; and compare the query document embedding to the candidate document embedding, wherein the document is identified based on the comparison.

Some examples of the non-transitory computer readable medium further include code executable by the processor to generate a plurality of candidate document embeddings for a plurality of candidate documents and compare the query document embedding to the plurality of candidate document embeddings, wherein the document is identified based on the comparison.

Some examples of the non-transitory computer readable medium further include code executable by the processor to extract a title sentence and a description sentence of the candidate document, wherein the plurality of candidate sentences includes the title sentence and the description sentence. Some examples of the non-transitory computer readable medium further include code executable by the processor to divide the candidate document into the plurality of candidate sentences based at least in part on a sentence delimiter.

Some examples further include code executable by the processor to remove irrelevant text from the candidate document to obtain clean document text, wherein the plurality of candidate sentences are extracted from the clean document text. In some cases, the code is further executable by the processor to identify common text from a plurality of candidate documents, wherein the irrelevant text is based on the common text.

An apparatus, system, and method for article recommendation are described. One or more aspects of the apparatus, system, and method include at least one processor; a memory including instructions executable by the processor; a sentence encoder configured to encode a plurality of candidate sentences from a candidate document to obtain a plurality of contextual sentence embeddings; and an aggregation component configured to generate a candidate document embedding by combining the plurality of contextual sentence embeddings.

### BRIEF DESCRIPTION OF THE DRAWINGS

FIG. 1 shows an example of a document search system according to aspects of the present disclosure.

FIG. 2 shows an example of a document search apparatus according to aspects of the present disclosure.

FIG. 3 shows an example of a pipeline for finding similar documents according to aspects of the present disclosure.

FIG. 4 shows an example of a method for finding similar articles according to aspects of the present disclosure.

FIG. 5 shows an example of a method for determining whether a candidate document matches a document query according to aspects of the present disclosure.

FIG. 6 shows an example of comparing documents based on metadata according to aspects of the present disclosure.

FIG. 7 shows an example of a computing device according to aspects of the present disclosure.

### DETAILED DESCRIPTION

Users consume textual content in many forms. For example, users may follow various political and technology news websites. Some applications and browsers can suggest articles to users based on their past search history. In some cases, a user may seek out tutorials or help articles to assist them with a task, such as tasks related to the use of software.

Topic modeling techniques such as Latent Dirichlet Allocation (LDA) and unsupervised grouping methods are often used to classify articles into categories. LDA, for example, iteratively assigns words to topics and updates probability distributions until convergence is reached. Unsupervised methods such as k-means or hierarchical clustering similarly utilize frequency distributions of words to classify or encode documents. Some techniques involve using machine learning (ML) models such as artificial neural networks (ANNs) to generate encodings for documents, so documents of varying sizes can be transformed into same-shape encodings and compared. However, even if the comparative approaches can generate same-shape encodings, they are often sensitive to the source's length, and can generate inaccurate representations from shorter documents.

The above-mentioned techniques are based on individual words of the document and may not capture the context of the words (e.g., from neighboring). As an example, consider a user who wishes to find articles similar to a current article: “add background content to images.” The word-based techniques may classify articles such as “remove background content from images” or “remove background noise from recording” as similar to the user's current article due to a large number of shared words. However, the tasks may be very different.

Embodiments of the present disclosure include a sentence-level encoder configured to generate representations for each sentence of a document. Examples of the encoder include a transformer-based network that is configured (e.g., pretrained) to capture intra-sentence context. For example, the encoder will generate an encoding for “add background to an image” that is measurably distant from an encoding from “remove background from an image.” Accordingly, such encodings may be referred to as contextual sentence embeddings.

Embodiments further include an aggregation component to combine the sentence embeddings into a document embedding. The document embedding is representative of information from the entire document and can be used to identify similar documents by direct comparison such as cosine similarity. In some cases, a scrubbing component is used to remove texts that are common to all articles, as well as irrelevant text such as hyperlinks, SEO material, code snippets, etc. In some cases, a parsing component is used to divide the sentences for processing. In many cases, articles include a title, a description, and a body of text. Some embodiments further include a sentence extracting component configured to extract and label different types of sentences.

Accordingly, embodiments include several components that form an end-to-end framework for generating meaningful vector representations of documents that capture the context of the documents. The representations can be used to identify articles that are relevant to each other, and not merely articles that share a large number of words. Furthermore, embodiments are robust to large variations in article length, and do not generate sparse or unusable data from short articles. For example, embodiments can generate document embeddings from articles that have a title and a description, but no body text.

By utilizing contextual document embeddings, embodiments of the present disclosure are configured to recommend articles to users that are more relevant than articles that may be recommended by comparative systems. Accordingly, embodiments provide users with an improved reading experience, and the users may be more likely to continue browsing within the article's website.

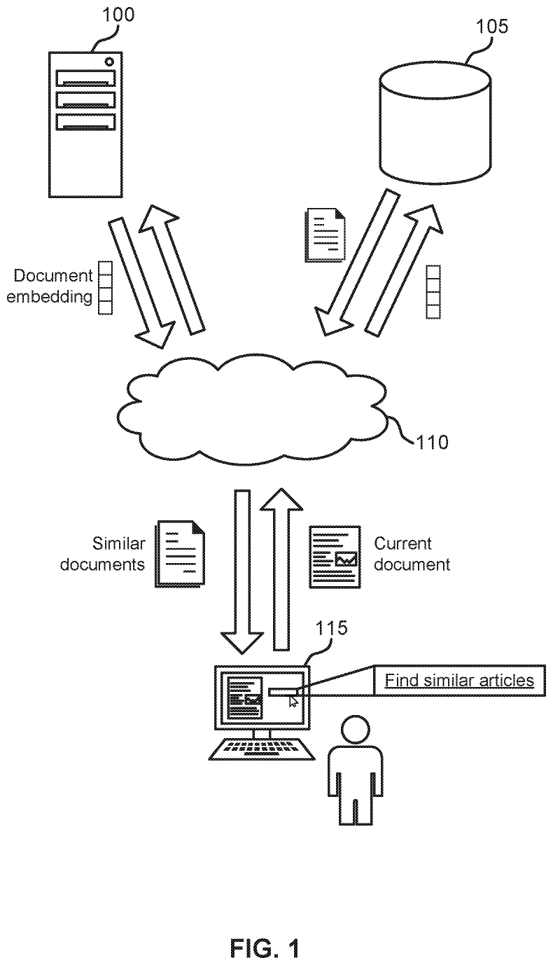

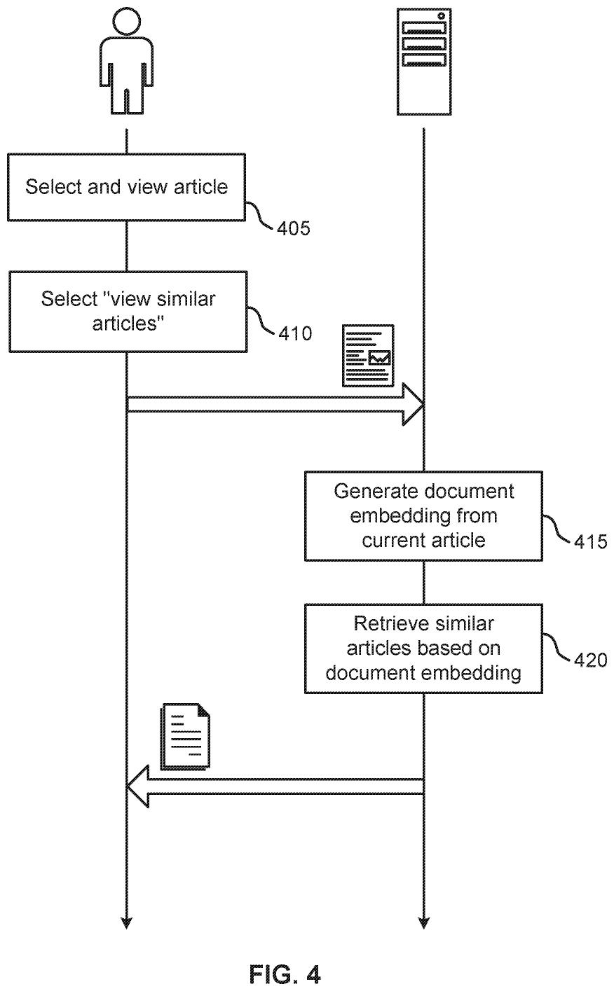

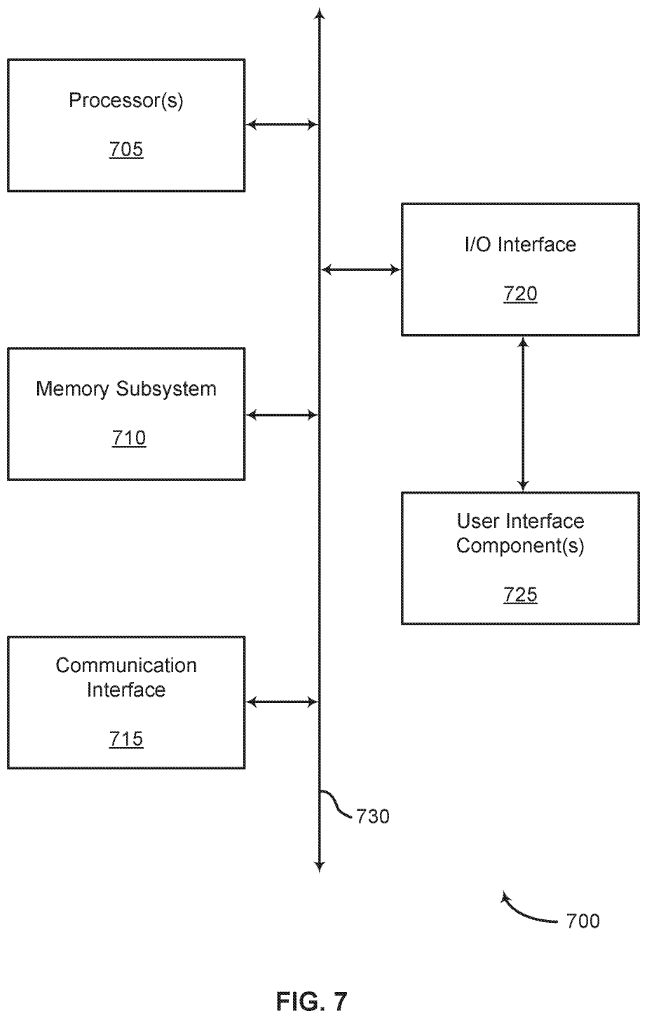

A document search system, a document search apparatus, and an example operating pipeline are described with reference to FIGS. 1-3. Methods for finding similar articles are described with reference to FIGS. 4-6. A computing device that may be used to implement the document search apparatus is described with reference to FIG. 7.

### Document Search System

An apparatus for article recommendation is described. One or more aspects of the apparatus include at least one processor; a memory including instructions executable by the processor; a sentence encoder configured to encode a plurality of candidate sentences from a candidate document to obtain a plurality of contextual sentence embeddings; and an aggregation component configured to generate a candidate document embedding by combining the plurality of contextual sentence embeddings.

Some examples of the apparatus, system, and method further include a comparison component configured to compute a similarity between the candidate document embedding and a query document embedding. In some aspects, the comparison component is further configured to compute a similarity between a candidate document and a query document based on metadata.

Some examples of the apparatus, system, and method further include a sentence extracting component configured to extract a title sentence and a description sentence of the candidate document. Some examples further include a parsing component configured to divide the candidate document into the plurality of candidate sentences based at least in part on a sentence delimiter. Some examples of the apparatus, system, and method further include a scrubbing component configured to remove irrelevant text from the candidate document to obtain clean document text.

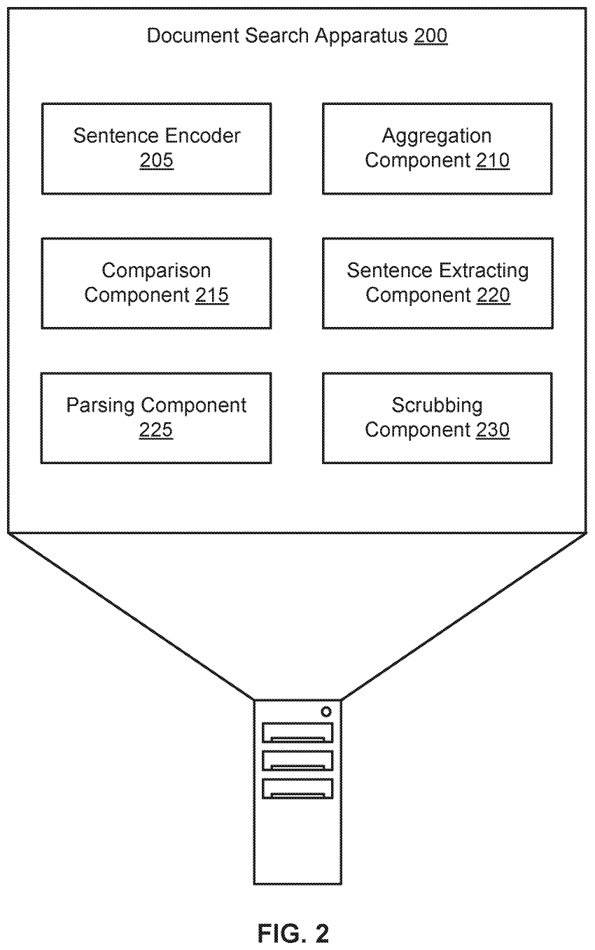

FIG. 1 shows an example of a document search system according to aspects of the present disclosure. The example shown includes document search apparatus 100, database 105, network 110, and user interface 115. Document search apparatus 100 is an example of, or includes aspects of, the corresponding element described with reference to FIG. 2.

In an example process, a user browses an article via a user interface 115 such as a web browser. Once the user has finished the article, they select a button or link that indicates similar articles, such as a button labeled “Find similar articles.” Then, the document is sent to document search apparatus 100 and processed. In some cases, the processing involves removing irrelevant text, parsing the article's text into sentences, encoding the sentences into sentence embeddings, and then generating a document embedding from the sentence embeddings. The document search apparatus 100 then compares the document embedding to document embeddings stored in database 105, and retrieves similar documents based on the comparison. In some embodiments, network 110 facilitates the transfer of information between document search apparatus 100, network 110, and user interface 115.

Document search apparatus 100 may be implemented on a user's local machine, or one or more components of document search apparatus 100 may be implemented on a server. A server provides one or more functions to users linked by way of one or more of the various networks such as network 110. In some cases, the server includes a single microprocessor board, which includes a microprocessor responsible for controlling all aspects of the server. In some cases, a server uses microprocessor and protocols to exchange data with other devices/users on one or more of the networks 110 via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus. The present embodiments are not implemented thereto, however, and one or more components of document search apparatus 100 may be implemented on a user device such as a personal computer or a mobile phone.

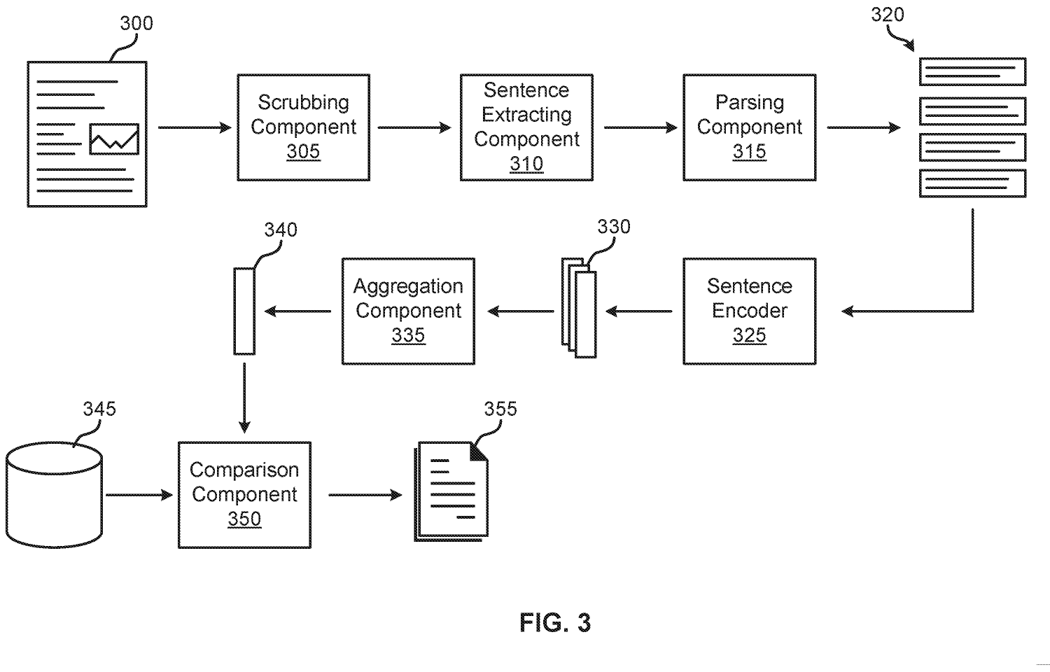

Information used by document search apparatus 100, such as parameters of a sentence encoder and cached sentence and document embeddings, may be stored on a database such as database 105. A database is an organized collection of data. For example, a database stores data in a specified format known as a schema. In some cases, database 105 includes data storage, as well as a server to manage disbursement of data and content. A database may be structured as a single database, a distributed database, multiple distributed databases, or an emergency backup database. In some cases, a database controller may manage data storage and processing in database 105. In some cases, a user interacts with the database controller. In other cases, the database controller may operate automatically without user interaction. Database 105 is an example of, or includes aspects of, the corresponding element described with reference to FIG. 3.

Network 110 is sometimes referred to as a “cloud.” A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

A user interface enables a user to interact with a device. For example, user interface 115 may be configured to receive commands from and present content to a user. In some embodiments, user interface includes an audio device, such as an external speaker system, an external display device such as a display screen, or an input device (e.g., remote control device interfaced with user interface 115 directly or through an IO controller module). In some cases, user interface 115 includes a graphical user interface (GUI).

FIG. 2 shows an example of a document search apparatus 200 according to aspects of the present disclosure. The example shown includes document search apparatus 200, sentence encoder 205, aggregation component 210, comparison component 215, sentence extracting component 220, parsing component 225, and scrubbing component 230. The components described with reference to FIG. 2 are examples of, or include aspects of, the corresponding elements described with reference to FIG. 3.

Embodiments of document search apparatus 200 include several components. The term “component” is used to partition the functionality enabled by the processor(s) and the executable instructions included in the computing device used to implement document search apparatus 200 (such as the computing device described with reference to FIG. 7). The partitions may be implemented physically, such as through the use of separate circuits or processors for each component or may be implemented logically via the architecture of the code executable by the processors.

Sentence encoder 205 is configured to transform a sentence into a vector representation referred to as a contextual sentence embedding. Embodiments of sentence encoder 205 include a transformer based neural network model. Some examples of the neural network model are pre-trained on a dataset including sentence pairs, and during the training the model learns to predict whether the sentences within a pair are similar. Some embodiments of sentence encoder 205 are based on a modified sentence BERT (SBERT) architecture. In at least one example, sentence encoder 205 includes an SBERT model with its final fully connected layer removed, and the representation of the sentence stored is extracted from the model as the contextual sentence embedding.

According to some aspects, sentence encoder 205 encodes a set of candidate sentences from a candidate document to obtain a set of contextual sentence embeddings, where each of the set of contextual sentence embeddings represents a semantic context of a corresponding sentence from the set of candidate sentences. In some examples, sentence encoder 205 encodes a set of query sentences from a query document to obtain a set of query sentence embeddings. The sentence embeddings from the query document can be aggregated into a query document embedding, and similarly so for the candidate document embedding. Then, the two documents can be compared based on the document embeddings.

Aggregation component 210 is configured to combine the contextual sentence embeddings generated by sentence encoder 205. Some embodiments of aggregation component 210 combine the values of the contextual sentence embeddings by using a representative aggregate statistic of the contextual sentence embeddings, such as an average. Some embodiments of aggregation component 210 combine the values using mean-pooling.

According to some aspects, aggregation component 210 generates a candidate document embedding from a document stored in a database by combining the set of contextual sentence embeddings generated from sentence encoder 205. In some examples, aggregation component 210 generates a query document embedding from an input query document by combining a set of query sentence embeddings. In some examples, aggregation component 210 generates a set of candidate document embeddings for a set of candidate documents, such as for a set including all documents stored in a database.

Comparison component 215 is configured to compare two document embeddings to determine a measure of their similarity. There are several ways to compare two vectors to generate a value of their similarity, including Euclidean distance, dot product, and cosine similarity. Some embodiments of comparison component 215 are configured to compare two document embeddings using cosine similarity. In some cases, cosine similarity provides a more accurate measure of similarity between two embeddings, as cosine similarity can avoid biases towards popular sentences.

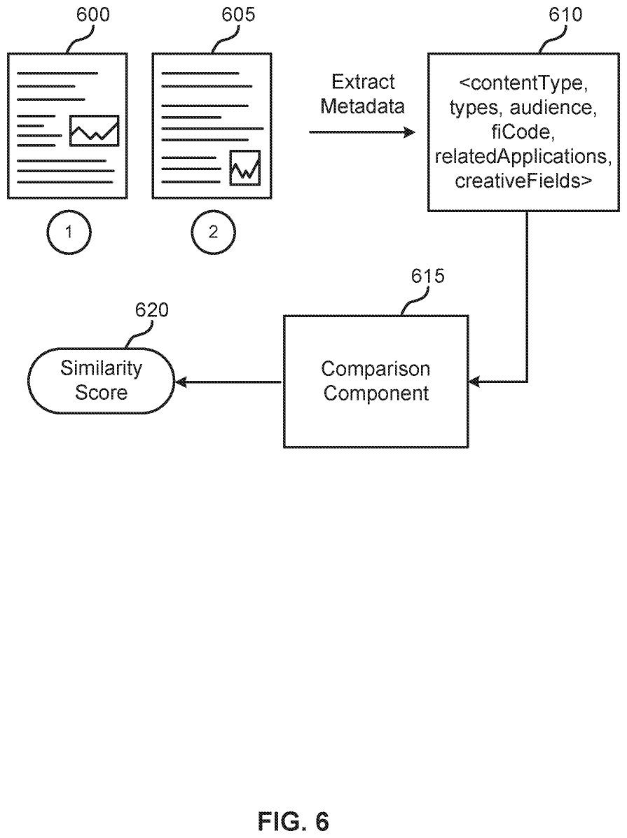

According to some aspects, comparison component 215 compares the query document embedding to the candidate document embedding, where the candidate document is provided based on the comparison. In some examples, comparison component 215 compares the query document embedding to the set of candidate document embeddings, where the candidate document is provided based on the comparison. In some aspects, comparison component 215 is further configured to compute a similarity between a candidate document and a query document based on metadata. For example, comparison component 215 may verify the similarity of two documents by comparing words or labels contained in the documents' metadata. Comparison component 215 is an example of, or includes aspects of, the corresponding element described with reference to FIGS. 3 and 6.

Sentence extracting component 220 is configured to extract sentences from various parts of a document, including its title, description, and body. In some embodiments, sentence extracting component 220 applies a label to each sentence according to its original location in the document. In some cases, each sentence is assigned a weighting value based on the label, which influences the extent of the sentence's impact in the final document embedding.

According to some aspects, sentence extracting component 220 extracts a title sentence and a description sentence of the candidate document, where the set of candidate sentences includes the title sentence and the description sentence. Sentence extracting component 220 is an example of, or includes aspects of, the corresponding element described with reference to FIG. 3.

Parsing component 225 is configured to divide a continuous string of sentences into multiple sentences. For example, parsing component 225 may process a stream of text to generate a data structure such as an array that stores each sentence in its own index of the array. According to some aspects, parsing component 225 divides the candidate document into the set of candidate sentences based on a sentence delimiter, such as a period, or a combination of a period character and a space character. Parsing component 225 is an example of, or includes aspects of, the corresponding element described with reference to FIG. 3.

Scrubbing component 230 is configured to remove text that is not representative of the document. Some embodiments of scrubbing component remove certain texts that are not natural language, such as hyperlinks, SEO optimization tags, code snippets, and the like. Some embodiments of scrubbing component remove text that is repeated across many articles, such as high value action (HVA) texts on top of buttons and other interactable items.

According to some aspects, scrubbing component 230 removes irrelevant text from the candidate document to obtain clean document text, where the set of candidate sentences are extracted from the clean document text. In some examples, scrubbing component 230 identifies common text from a set of candidate documents, where the irrelevant text is based on the common text. Scrubbing component 230 is an example of, or includes aspects of, the corresponding element described with reference to FIG. 3.

FIG. 3 shows an example of a pipeline for finding similar documents according to aspects of the present disclosure. The example shown includes query document 300, scrubbing component 305, sentence extracting component 310, parsing component 315, document sentences 320, sentence encoder 325, contextual sentence embeddings 330, aggregation component 335, query document embedding 340, database 345, comparison component 350, and similar documents 355. The components described with reference to FIG. 3 are examples of, or include aspects of, the corresponding elements described with reference to FIG. 2.

Database 345 is an example of, or includes aspects of, the corresponding element described with reference to FIG. 1. Comparison component 350 is an example of, or includes aspects of, the corresponding element described with reference to FIGS. 2 and 6.

In the example shown, the system receives query document 300. Query document 300 may originate from a user; for example, a web browser or other application including a GUI may identify an article that the user is currently reading, and the article may be input to the system as query document 300.

Scrubbing component 305 removes irrelevant text from query document 300. In some examples, scrubbing component 305 identifies text that is common to all articles in a database, such as text overlaid in buttons and in hyperlinks. Then, scrubbing component 305 removes the identified text.

Sentence extracting component 310 may extract bodies of text from different sections of the document. For example, some articles may include a title, a description, and a body section. The sentence extracting component 310 may identify the different sections according to one or more labels supplied with the document, such as HTML tags. In some cases, sentence extracting component 310 labels the bodies of text according to the section they originated from.

Parsing component 315 divides the bodies of text into sentences to form document sentences 320. For example, parsing component 315 may process a stream of text to generate a data structure such as an array that stores each sentence in its own index of the array. According to some aspects, parsing component 315 divides the candidate document into the set of candidate sentences based on a sentence delimiter, such as a period, or a combination of a period character and a space character.

Sentence encoder 325 transforms each sentence in document sentences 320 to generate contextual sentence embeddings 330. Embodiments of sentence encoder 325 include a neural network with one or more transformer architectures. In some cases, sentence encoder 325 is trained in a separate training phase on a dataset including sentences. Some embodiments of sentence encoder 325 are based on a pre-trained Sentence BERT (SBERT) architecture.

Aggregation component 335 combines contextual sentence embeddings 330 to form query document embedding 340. Some examples of aggregation component 335 include one or more max pooling layers configured to aggregate values from multiple vectors to form a single vector, e.g., document embedding 340.

Comparison component 350 compares the document embedding 340 to one or more candidate document embeddings stored in database 345. For example, comparison component 350 may compare document embedding 340 to each candidate document embedding by computing a cosine similarity between the embeddings. Then, comparison component 350 identifies the similar documents 355 based on this comparison. For example, comparison component 350 may identify the document with the highest cosine similarity score, k-documents with the highest similarity scores, or all documents above a threshold similarity score.

In an embodiment, the system presents similar documents 355 to a user via a graphical user interface. In some embodiments, the system chooses the document(s) that are the most similar to the query document 300 and directs the user to the document(s) once the user selects “view similar articles.”

### Finding Similar Articles

A method for article recommendation is described. One or more aspects of the method include receiving a document query; encoding a plurality of candidate sentences from a candidate document to obtain a plurality of contextual sentence embeddings, wherein each of the plurality of contextual sentence embeddings represents a semantic context of a corresponding sentence from the plurality of candidate sentences; generating a candidate document embedding by combining the plurality of contextual sentence embeddings; and providing the candidate document in response to the document query based on the candidate document embedding.

Some examples of the method, apparatus, non-transitory computer readable medium, and system further include obtaining a query document based on the document query. Some examples further include encoding a plurality of query sentences from the query document to obtain a plurality of query sentence embeddings. Some examples further include generating a query document embedding by combining the plurality of query sentence embeddings. Some examples further include comparing the query document embedding to the candidate document embedding, wherein the candidate document is provided based on the comparison.

Some examples of the method, apparatus, non-transitory computer readable medium, and system further include generating a plurality of candidate document embeddings for a plurality of candidate documents. Some examples further include comparing the query document embedding to the plurality of candidate document embeddings, wherein the candidate document is provided based on the comparison.

Some examples of the method, apparatus, non-transitory computer readable medium, and system further include extracting a title sentence and a description sentence of the candidate document, wherein the plurality of candidate sentences includes the title sentence and the description sentence. Some examples further include dividing the candidate document into the plurality of candidate sentences based at least in part on a sentence delimiter.

Some examples of the method, apparatus, non-transitory computer readable medium, and system further include removing irrelevant text from the candidate document to obtain clean document text, wherein the plurality of candidate sentences are extracted from the clean document text. Some examples further include identifying common text from a plurality of candidate documents, wherein the irrelevant text is based on the common text.

FIG. 4 shows an example of a method 400 for finding similar articles according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 405, a user selects and views an article. The user may do so through a graphical user interface (GUI) such as a web browser. At operation 410, the user selects “view similar articles”, or otherwise indicates their desire to see similar articles. For example, the user might select a button or link on the website with the text “view similar articles.”

At operation 415, the system generates document embedding from current article. The current article may be determined from the webpage the user is currently visiting. The document embedding may be formed as a tensor of values that encodes the contextual meaning of the document. The system may generate the document embedding according to the process described with reference to FIG. 3.

At operation 420, the system retrieves similar articles based on document embedding. For example, the system may compare the document embedding of the current article to other document embeddings stored within a database, and retrieve the similar articles based on the comparison. In at least one embodiment, the system has already pre-processed the current article, and does not need to embed it upon the user's selection of “view similar articles.”

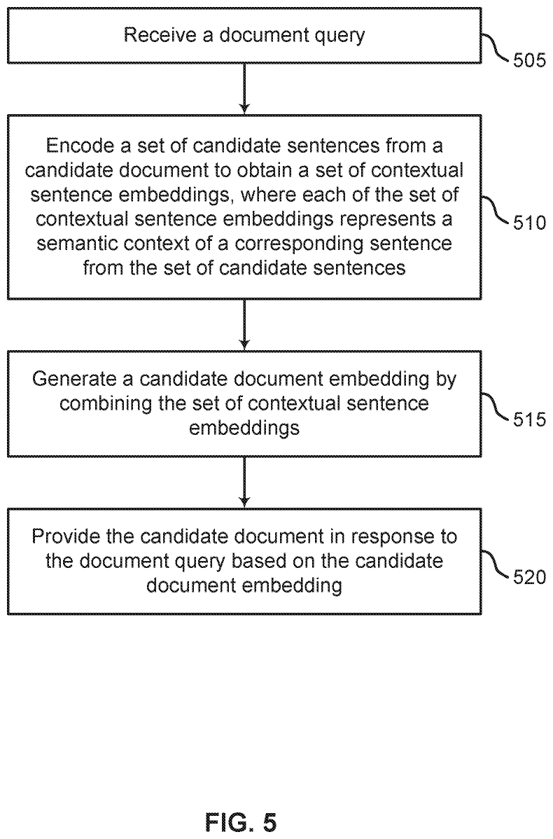

FIG. 5 shows an example of a method 500 for determining whether a candidate document matches a document query according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 505, the system receives a document query. In some cases, the operations of this step refer to, or may be performed by, a document search apparatus as described with reference to FIGS. 1 and 2. The system may receive the document query from a user in a similar process to the one described with reference to FIG. 4, or through an automated process. The document query may be an article that is currently being read by the user, a reference to the article, or a text query.

At operation 510, the system encodes a set of candidate sentences from a candidate document to obtain a set of contextual sentence embeddings, where each of the set of contextual sentence embeddings represents a semantic context of a corresponding sentence from the set of candidate sentences. For example, the system may encode sentences from candidate documents within a database. In some cases, the system encodes the sentences before the system is operated in production, e.g., before the system accepts document queries. In some cases, the operations of this step refer to, or may be performed by, a sentence encoder as described with reference to FIGS. 2 and 3.

At operation 515, the system generates a candidate document embedding by combining the set of contextual sentence embeddings. In some cases, the system generates the candidate document embedding or embeddings in a preparation process before the system is placed in production. In some cases, the operations of this step refer to, or may be performed by, an aggregation component as described with reference to FIGS. 2 and 3. For example, the aggregation component may perform a max pooling operation on the set of contextual sentence embeddings to generate the candidate document embedding. The technique used to combine the contextual sentence embeddings is not limited thereto, however, and various embodiments of the aggregation component may use different methods to combine the contextual sentence embeddings. For example, the aggregation component may extract an aggregate or representative statistical measure from each contextual sentence embedding and combine the statistical measures to form the candidate document embedding.

At operation 520, the system provides the candidate document in response to the document query based on the candidate document embedding. In some cases, the operations of this step refer to, or may be performed by, a document search apparatus as described with reference to FIGS. 1 and 2. For example, the system may compare the candidate document embedding with an embedding of the document query and determine the candidate document to be similar to the document query, and provide the candidate document based on the determination. In some embodiments, the determination of similarity is based on a cosine similarity between the embeddings.

FIG. 6 shows an example of comparing documents based on metadata according to aspects of the present disclosure. The example shown includes first document 600, second document 605, metadata 610, comparison component 615, and similarity score 620. Comparison component 615 is an example of, or includes aspects of, the corresponding element described with reference to FIGS. 2 and 3.

Embodiments of a document search apparatus are configured to compare two documents based on their metadata 610. In an example use case, the document search apparatus identifies two similar documents by generating document embeddings and comparing the embeddings. Then, the document search apparatus may verify their similarity (as well as the accuracy of the embeddings) by comparing the metadata of the two documents.

In one example, the document search apparatus extracts metadata from first document 600 and second document 605. The system may keep the metadata 610 in separate data structures corresponding to each document. Then a comparison component 615 such as the one described with reference to FIGS. 2 and 3 computes a Jaccard similarity or an intersection over union (IOU) between the metadata 610 of each document. The comparison component 615 may then compute a similarity score 620 based on the Jaccard similarity or the IOU, where the similarity score 620 indicates a measure of similarity between the two documents.

In some cases, the similarity score 620 is considered a “ground-truth” similarity score when first document 600 and second document 605 are from a known schema that stores accurate metadata. For example, the metadata 610 may include various values that describe the documents that have been determined by human experts. Accordingly, similarity score 620 may be used to evaluate the accuracy of the document retrieval performed using the process described with reference to FIG. 3.

FIG. 7 shows an example of a computing device 700 according to aspects of the present disclosure. The example shown includes computing device 700, processor(s), memory subsystem 710, communication interface 715, I/O interface 720, user interface component(s), and channel 730.

In some embodiments, computing device 700 is an example of, or includes aspects of, document search apparatus 100 of FIG. 1. In some embodiments, computing device 700 includes one or more processors 705 that can execute instructions stored in memory subsystem 710 to receive a document query; encode a plurality of candidate sentences from a candidate document to obtain a plurality of contextual sentence embeddings, wherein each of the plurality of contextual sentence embeddings represents a semantic context of a corresponding sentence from the plurality of candidate sentences; generate a candidate document embedding by combining the plurality of contextual sentence embeddings; and provide the candidate document in response to the document query based on the candidate document embedding.

According to some aspects, computing device 700 includes one or more processors 705. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 710 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 715 operates at a boundary between communicating entities (such as computing device 700, one or more user devices, a cloud, and one or more databases) and channel 730 and can record and process communications. In some cases, communication interface 715 is provided to enable a processing system coupled to a transceiver (e.g., a transmitter and/or a receiver). In some examples, the transceiver is configured to transmit (or send) and receive signals for a communications device via an antenna.

According to some aspects, I/O interface 720 is controlled by an I/O controller to manage input and output signals for computing device 700. In some cases, I/O interface 720 manages peripherals not integrated into computing device 700. In some cases, I/O interface 720 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 720 or via hardware components controlled by the I/O controller.

According to some aspects, user interface component(s) 725 enables a user to interact with computing device 700. In some cases, user interface component(s) 725 include an audio device, such as an external speaker system, an external display device such as a display screen, an input device (e.g., a remote-control device interfaced with a user interface directly or through the I/O controller), or a combination thereof. In some cases, user interface component(s) 725 includes a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also, the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
receiving a document query;
encoding a plurality of candidate sentences from a candidate document to obtain a plurality of contextual sentence embeddings, wherein each of the plurality of contextual sentence embeddings represents a semantic context of a corresponding sentence from the plurality of candidate sentences;
generating a candidate document embedding by combining the plurality of contextual sentence embeddings; and
providing the candidate document in response to the document query based on the candidate document embedding.

2. The method of claim 1, further comprising:
obtaining a query document based on the document query;
encoding a plurality of query sentences from the query document to obtain a plurality of query sentence embeddings;
generating a query document embedding by combining the plurality of query sentence embeddings; and
comparing the query document embedding to the candidate document embedding, wherein the candidate document is provided based on the comparison.

3. The method of claim 2, further comprising:
generating a plurality of candidate document embeddings for a plurality of candidate documents; and
comparing the query document embedding to the plurality of candidate document embeddings, wherein the candidate document is provided based on the comparison.

4. The method of claim 1, further comprising:
extracting a title sentence and a description sentence of the candidate document, wherein the plurality of candidate sentences includes the title sentence and the description sentence.

5. The method of claim 1, further comprising:
dividing the candidate document into the plurality of candidate sentences based at least in part on a sentence delimiter.

6. The method of claim 1, further comprising:
removing irrelevant text from the candidate document to obtain clean document text, wherein the plurality of candidate sentences are extracted from the clean document text.

7. The method of claim 6, further comprising:
identifying common text from a plurality of candidate documents, wherein the irrelevant text is based on the common text.

8. A non-transitory computer readable medium storing code, the code comprising instructions executable by a processor to:
encode a plurality of candidate sentences from a candidate document to obtain a plurality of contextual sentence embeddings, wherein each of the plurality of contextual sentence embeddings represents a semantic context of a corresponding sentence from the plurality of candidate sentences;
generate a candidate document embedding by combining the plurality of contextual sentence embeddings; and
identify a document based on the candidate document embedding.

9. The non-transitory computer readable medium of claim 8, wherein the code further comprises instructions executable by the processor to:
obtain a query document based on a document query;
encode a plurality of query sentences from the query document to obtain a plurality of query sentence embeddings;
generate a query document embedding by combining the plurality of query sentence embeddings; and
compare the query document embedding to the candidate document embedding, wherein the document is identified based on the comparison.

10. The non-transitory computer readable medium of claim 9, wherein the code further comprises instructions executable by the processor to:
generate a plurality of candidate document embeddings for a plurality of candidate documents; and
compare the query document embedding to the plurality of candidate document embeddings, wherein the document is identified based on the comparison.

11. The non-transitory computer readable medium of claim 8, wherein the code further comprises instructions executable by the processor to:
extract a title sentence and a description sentence of the candidate document, wherein the plurality of candidate sentences includes the title sentence and the description sentence.

12. The non-transitory computer readable medium of claim 8, wherein the code further comprises instructions executable by the processor to:
divide the candidate document into the plurality of candidate sentences based at least in part on a sentence delimiter.

13. The non-transitory computer readable medium of claim 8, wherein the code further comprises instructions executable by the processor to:
remove irrelevant text from the candidate document to obtain clean document text, wherein the plurality of candidate sentences are extracted from the clean document text.

14. The non-transitory computer readable medium of claim 13, wherein the code further comprises instructions executable by the processor to:
identify common text from a plurality of candidate documents, wherein the irrelevant text is based on the common text.

15. An apparatus comprising:
at least one processor;
a memory including instructions executable by the processor;
a sentence encoder configured to encode a plurality of candidate sentences from a candidate document to obtain a plurality of contextual sentence embeddings; and
an aggregation component configured to generate a candidate document embedding by combining the plurality of contextual sentence embeddings.

16. The apparatus of claim 15, further comprising:
a comparison component configured to compute a similarity between the candidate document embedding and a query document embedding.

17. The apparatus of claim 16, wherein:
the comparison component is further configured to compute a similarity between a candidate document and a query document based on metadata.

18. The apparatus of claim 15, further comprising:
a sentence extracting component configured to extract a title sentence and a description sentence of the candidate document.

19. The apparatus of claim 15, further comprising:
a parsing component configured to divide the candidate document into the plurality of candidate sentences based at least in part on a sentence delimiter.

20. The apparatus of claim 15, further comprising:
a scrubbing component configured to remove irrelevant text from the candidate document to obtain clean document text.
